(19) United States
(12) Patent Application Publication
(10) Pub. No.: US 2008/0287587 A1
(43) Pub. Date: Nov. 20, 2008

(54) Method for forming polymer-clay nanocomposite latex and its application on sealing and semi-conductive materials

(75) Inventors: King-Fu Lin, Taipei City (TW); An-Ting Chien, Taipei City (TW); Ming-Huei Yen, Taipei City (TW); Chia-Hsin Lee, Taipei City (TW); Ting-Hsiang Weng, Taipei City (TW); Chuan-Cheng Chou, Taipei City (TW)

Correspondence Address: WPAT, PC, 7225 BEVERLY ST., ANNANDALE, VA, 22003, US

(73) Assignee: NATIONAL TAIWAN UNIVERSITY, Taipei City (TW)

(21) Appl. No.: 11/840,972

(22) Filed: Aug. 19, 2007

(30) Foreign Application Priority Data
May 15, 2007 (TW) 096117286

(51) Int. Cl. C08K 3/36

(52) U.S. Cl. 524/445

(57) ABSTRACT

The present invention discloses a method to prepare the polymer-clay nanocomposite latex. At first, a clay and a water-soluble initiator are mixed in water to form an intermediate solution, in which the initiator is absorbed or intercalated into the clay. Then, at least one monomer from vinyl ester, acrylic and acrylamide derivatives is added into the intermediate solution for soap-free emulsion polymerization, which may also be added with some other monomers such as acrylic acid, maleic anhydride, vinyl chloride, acrylonitrile ethylene, et al. for copolymerization. During soap-free emulsion polymerization, the radicals from the dissociated initiators will react with the monomers to form the monomer radicals, which tend to diffuse into the interlayer region of clays for further polymerization and eventually exfoliate the clays. The prepared exfoliated polymer-clay nanocomposite latex can be cast into a vapor-impermeable film so that it can be used as a sealing material or coating. The exfoliated clay in nanoplatelet form is a two-dimensional electrolyte nanomaterial and its aqueous solution is conductive. The exfoliated clay aqueous solutions can be prepared by removing the polymer matrix from the nanocomposite latex with solvent. As the exfoliated clay solution is cast into a film with the clay content is more than or equal to 80 wt %, the film is semi-conductive. Thus, the exfoliated clay aqueous solutions can be applied to the electronic materials and organic/inorganic multilayer composite films.

### BACKGROUND OF THE INVENTION

1. Field of the Invention

The present invention is generally related to a method for forming nanocomposite latex, and more particularly to a method for forming polymer-clay nanocomposite latex and its application on sealing materials and two-dimensional electrolyte nanomaterials.

2. Description of the Prior Art

The term ^{┌}Nanocomposites_{┘} was first coined by Roy, Komarneni and their colleagues sometime during the period 1982˜1983. The definition was applied to the nanosizing inorganic materials in the 1-100 nm range that can be well dispersed in organic matrixes to form functional nanocomposites.

Clays are the most natural abundant minerals and available as inexpensive materials. The structure of clay is composed of layered silicate. The interlayer region of clay absorbs certain amount of cations, including Li⁺, Na⁺, Ca²⁺, Mg²⁺, Ba²⁺, La³⁺, and Ce²⁺. There are many strategies and variety of methods attempting to exfoliate the clays. Among them, organo-modification of clay is usually the primary step. After organo-modifying, the clay can be well-dispersed in polymer.

Alkyl ammonium ions (R—NH⁴⁺) were often used as modifiers for clay. After the treatment, clay possesses organo-affinity with expanded interlayer thickness. The swollen inlayer thickness of organo-clay is dependent on the chain length of modifier and the cation exchange capacity of clay. After cation-exchanging with clay, modifier might have different chain arrangements, such as parallel arrangement, perpendicular arrangement, and even double-layered arrangement, influenced by the chain length and piling density of alkyl ammonium ions. Besides, the longer the chain length of modifier is, and the larger the cation exchange capacity is, the thicker the swollen interlayer would be. Nevertheless, clay can be also intercalated by monomers, polymers or other additives to change the surface properties of clay. According to the aforesaid, the traditional method only increases the interlayer region of clay, but it is unable to achieve the purpose that the clay be exfoliated completely. Therefore, an improved method is required to resolve the above-mentioned problems for the traditional method.

### SUMMARY OF THE INVENTION

In accordance with the present invention, and a method for forming polymer-clay nanocomposite latex and its application on sealing materials and two-dimensional electrolyte nanomaterials.

The first objective of the present invention is that a series of partial water-soluble monomers, including vinyl ester, acrylic and acrylamide derivatives, such as methyl methacrylate, methyl acrylate, vinyl acetate, n-isopropylacrylamide and glycidyl methacrylate, were used to fabricate polymer-Montmorillonite (MMT) nanocomposites through soap-free emulsion polymerization, while MMT was intercalated by potassium persulfate (KPS) initiator in advance.

The second objective of the present invention is to remove the polymer matrix from the nanocomposite latex with solvent, so as to form an exfoliated clay aqueous solutions.

Accordingly, the present invention discloses a method to prepare the polymer-clay nanocomposite latex. At first, a clay and a water-soluble initiator are mixed in water to form an intermediate solution, in which the initiator is absorbed or intercalated into the clay. Then, at least one monomer from vinyl ester, acrylic and acrylamide derivatives is added into the intermediate solution for soap-free emulsion polymerization, which may also be added with some other monomers such as acrylic acid, maleic anhydride, vinyl chloride, acrylonitrile, ethylene, et al. for copolymerization. During soap-free emulsion polymerization, the radicals from the dissociated initiators will react with the monomers to form the monomer radicals, which tend to diffuse into the interlayer region of clays for further polymerization and eventually exfoliate the clays. The prepared exfoliated polymer-clay nanocomposite latex can be cast into a vapor-impermeable film so that it can be used as a sealing material or coating. The exfoliated clay solutions can also be prepared by removing the polymer matrix from the nanocomposite latex with solvent. The exfoliated clay in aqueous solutions exhibits two-dimensional electrolyte behavior, which can dissociate into ions that are conductive. As the exfoliated clay solution is cast into a film with the clay content more than or equal to 80 wt %, the film is also semi-conductive. Thus, the exfoliated clay solutions can be applied to the electronic materials and organic/inorganic multilayer composite films.

### BRIEF DESCRIPTION OF THE DRAWINGS

FIG. 1 is TEM images of (a) PVAc-MMT nanocomposite with 5 wt % MMT, and (b) its recovered MMT nanoplatelets after removal of PVAc;

FIG. 2 shows the X-ray diffraction patterns of PVAc-MMT nanocomposite with different weight percent of MMT;

FIG. 3 shows the photographic pictures of PVAc-MMT nanocomposite films with different weight percent of MMT;

FIG. 4 shows (a) Young's modules, and (b) Yield stress of PVAc-MMT and PVAcGMA-MMT nanocomposite films;

FIG. 5 shows SEM micrograph of PVAc-MMT surface with 5 wt % of MMT (a) before and (b) after eroded by acetone vapor;

FIG. 6 shows the residual weight percent of PVAc-MMT nanocomposite after the Soxhlet extraction in acetone;

FIG. 7 is the permeability coefficients of PVAc-MMT nanocomposite films with different weight percent of MMT. The insertion schematically illustrated the longer diffusive path and the direction of vapor passing through the film; and

FIG. 8 shows the reduced conductivites (Λ) of recovered exfoliated MMT nanoplatelet aqueous solutions with different concentrations.

### DESCRIPTION OF THE PREFERRED EMBODIMENTS

What is probed into the invention is a Method for forming polymer-clay nanocomposite latex and its application on sealing materials and two-dimensional electrolyte nanomaterials. Detail descriptions of the structure and elements will be provided as followed in order to make the invention thoroughly understood. The application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail as followed. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

Emulsion polymerization is heterogeneous free-radical polymerization. Three fundamental processes are necessary to describe the free-radical polymerization mechanism: initiation, propagation, and termination. When reacting begins, the initiator generates the initial free radical by thermal decomposition. The initial free radical can react with the monomer to form monomer radical. The mechanisms as following:

I→R*

R*+M→M1*

In the processes of propagation, monomer radical can also react with other monomer to form oligomeric radical.

M1*+M→M2*

M2*+M→M3*

General formula: Mn*+M→Mn+1*

In radical polymerization, growing chains terminate either by combination or by disproportionation. The two different types of termination processes, result in different groups at the end of the polymer chain. In initiator derived polymerizations, combination results in a single polymer molecule with two initiator fragments, one at each end of the chain. Disproportionation creates two polymer molecules, only one end of each has an initiator group. One of these chains has an unsaturated unit and the other has a saturated unit on the other end.

Termination by combination: Mn*+Mm*→Mn+m

Termination by disproportionation: Mn*+Mm*→Mn+Mm

Emulsion polymerization is a unique process employed for radical chain polymerization. Emulsification means oil and water phase were separated by surfactants or other amphiphilic materials in order to reduce surface energy. As the concentration is over Critical Micelle Concentration, the micelles were formed. One phase was dispersed in the other phase as small droplets or micelles. Generally monomer, surfactants and initiators are added to the waters to form micelles and to start polymerization. The final products are small latex particles with radius smaller than micro scale.

The advantages of emulsion polymerization are: The physical status of the emulsion system makes it easy to control the process. The problems of high viscosity and thermal uniformity often encountered in bulk polymerization are much less significant in emulsion polymerization. Radii of these latex particles were also uniform and controllable. Molecular weight and conversion are higher than other polymerization. The product of emulsion polymerization may be used directly without any purifications and separation, which includes paint resins, finishes, coating agents, floor polishes, processing agents, additives, and textile binders.

However, for traditional emulsion polymerization process, there are usually some impurities such as surfactants. The impurity may affect the properties of the final products. Recently, emulsifier-free or soap-free emulsion polymerization was attractive because it is a “clean: process and it also owns the same advantages as the tradition one has. The only difference is “No surfactant.”

In theory, there are three stages in emulsion polymerization. The first stage is nucleation. After the free radicals are formed by decomposition of initiators and reacted with monomer to produce monomer radicals in aqueous phase, the reaction center would be generated by several kinds of mechanisms such as micelle nucleation, homogeneous nucleation, droplet nucleation, coagulate nucleation, and nucleation in adsorbed emulsifier layer.

No matter what kind of mechanisms they are, these growing particles are primary particles originally. The monomer would be polymerized and dissolved into the growing particles continuously. Besides, monomer droplets can provide monomers for polymerization at the same time. The number of the growing particles and the reactions are at the steady state. This is the second stage. In theory, there is one propagating chain end per micelle.

In a first embodiment of the present invention, a method for forming polymer-clay nanocomposite latex and its application on sealing materials and two-dimensional electrolyte nanomaterials. At first, a clay (the cationic exchange capacity is about 7˜300 meq/100 g) and a water-soluble initiator are mixed in water to form an intermediate solution, in which the initiator is absorbed or intercalated into the clay. Furthermore, the weight of clay is about 1%˜30% weight of polymer-clay nanocomposite latex particles, and the weight of water-soluble initiator is about 2%˜20% weight of polymer-clay nanocomposite latex particles. Then, at least one monomer from vinyl ester, acrylic and acrylamide derivatives is added into the intermediate solution for soap-free emulsion polymerization, which may also be added with some other monomers such as acrylic acid, maleic anhydride, vinyl chloride, acrylonitrile, ethylene, et al. for copolymerization. During soap-free emulsion polymerization, the radicals from the dissociated initiators will react with the monomers to form the monomer radicals, which tend to diffuse into the interlayer region of clays for further polymerization and eventually form a polymer-clay nanocomposite latex. The application of polymer-clay nanocomposite latex is vary board, including latex paint, lacquer, surface paint, paper paint, process of leather, process of fiber, adhesive, fire-retardant paint, sun block, et al, and more particularly as a sealing material or coating.

In the embodiment, the mentioned clay comprises one selected from the group consisting of the following: smectite clay, vermiculite, halloysite, sericite, and mica. The mentioned smectite clay comprises one selected from the group consisting of the following: montmorillonite, saponite, hectorite, beidellite, nontronite, and stevensite. Therefore, the mentioned water-soluble initiator comprises one selected from the group consisting of the following: potassium persulfate (KPS), ammonium persulfate (APS), and soluble azo-initiator. The mentioned soluble azo-initiator comprises one selected from the group consisting of the following:
(a) 2,2′-Azobis[2-(2-imidazolin-2-yl)propane]dihydrochloride Temperature of decomposition is about 44° C.
(b)2,2′-Azobis(2-methylpropionamide)dihydrochloride Temperature of decomposition is about 57° C.
(c) 2,2′-Azobis{2-methyl-N-[2-(1-hydroxybuthyl)]propionamide} Temperature of decomposition is about 85° C.

In the embodiment, the mentioned vinyl ester comprises one selected from the group consisting of the following: vinyl acetate (VAc), vinyl propionate, and vinyl butyrate. The mentioned acrylic comprises one selected from the group consisting of the following: methyl acrylate, glycidyl acrylate, glycidyl methacrylate, and methyl methacrylate, et al. The mentioned acrylamide comprises one selected from the group consisting of the following: acrylamide, and n-isopropylacrylamide, et al.

For instance, vinyl acetate-ethylene emulsion (VAE) is a common adhesive, and its property described as following.

1. Wet Tack

2. Creep Resistance

3. Water Resistance

4. Alkali Resistance

5. Thickening Response

6. Operation Safety

### EXAMPLE

we extracted montmorillonite (MMT) (cationic exchange capacity (CEC)=127 meq/g) from the bentonite, which was quarried from the mountain side of Taitung in the east of Taiwan. MMT was treated with KPS in aqueous solution and freeze-dried. The resulting KPS-MMT can be either stored in powder form or suspended in de-ionized water under stir preparing for the next step of soap-free emulsion polymerization. To begin with the soap-free emulsion polymerization, vinyl aceate (VAc) monomers were added to the above KPS-MMT aqueous solution under stir. The solutions were maintained at 50° C. for 50 h first and then heated to 70° C. for ˜3 h until no further polymerization was detected. The conversion for VAc to polymerize into PVAc was ˜80%. The PVAc-MMT nanocomposite latex (nanocomposite latices containing 0, 1, 3, 5, and 10 wt % MMT) containing 1 wt % MMT was designated as PVAc-1% MMT nanocomposite latex and so on. Next, the fabricated PVAc-MMT nanocomposite latices were cast into a aluminum foil rectangular mode of 15 cm×45 cm and then heated to 50° C. in an oven. After 12 h, it was further heated to 70° C. to remove the residual water or monomer until a clear PVAc-MMT nanocomposite film of 0.15 mm in thickness was formed.

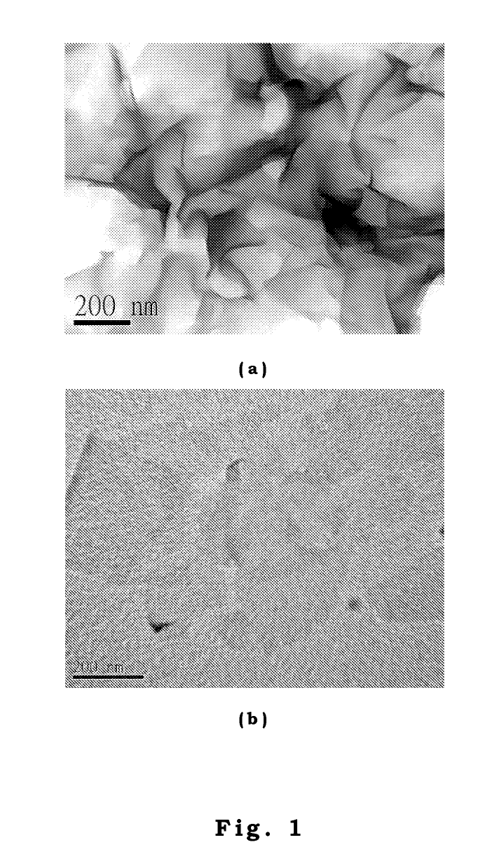

Typical TEM image of exfoliated PVAc-5% MMT nanocomposite latices is shown in FIG. 1a. PVAc not only exfoliated MMT but also adhered to the exfoliated MMT nanoplatelets so that no well defined PVAc texture in latex was observed. Because the exfoliated MMT nanoplatelets were coated by PVAc resins in the latex, they were much thicker compared to the neat exfoliated MMT nanoplatelets (see FIG. 1b). The prepared PVAc and its exfoliated MMT nanocomposite latices were then directly cast to form the films.

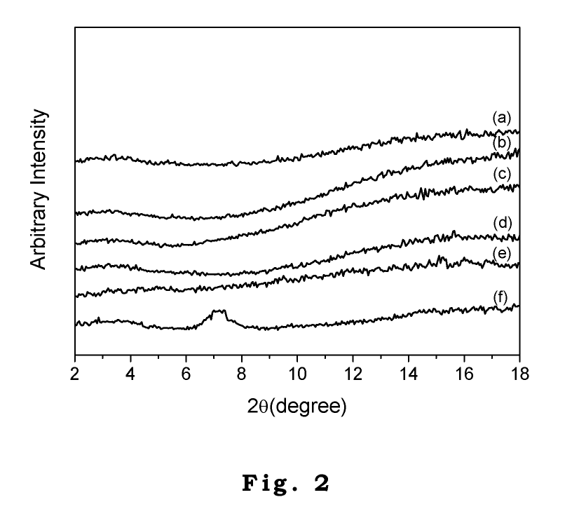

X-ray diffraction patterns of PVAc and the exfoliated PVAc-MMT nanocomposite films containing various weight percentage of MMT were presented in FIG. 2. The X-ray diffraction pattern of neat MMT particles was also included for comparison. The original interlayer d₀₀₁-spacing of 1.23 nm at 2θ=˜7° in the X-ray diffraction pattern of neat MMT disappeared for all the PVAc-MMT nanocomposite films, indicating that the MMT has been fully exfoliated in the films.

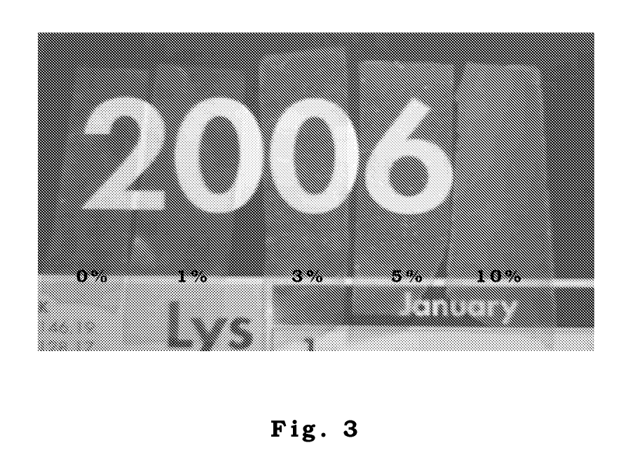

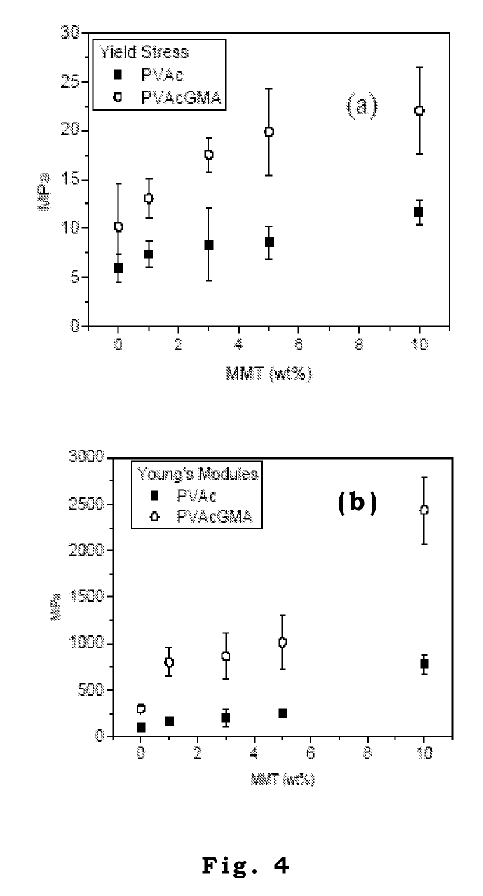

The cast PVAc-MMT nanocomposite films were transparent and colorless as illustrated in FIG. 3. Both Young's modules and yield stress of the films were significantly increased by incorporating the exfoliated MMT. The films can also be crosslinked by introducing the glycidyl methacrylate (GMA) crosslinkable monomers to copolymerize with vinyl acetate. Just like other polymer-clay systems, mechanical properties can be improved by MMT. In FIG. 4, modules and yield stress can be enhanced no matter PVAc or PVAc-co-GMA matrixes were chosen. As long as 5 wt % of MMT was incorporated, the modules and yield stress can be larger than twice compared to pure PVAc and PVAc-co-GMA.

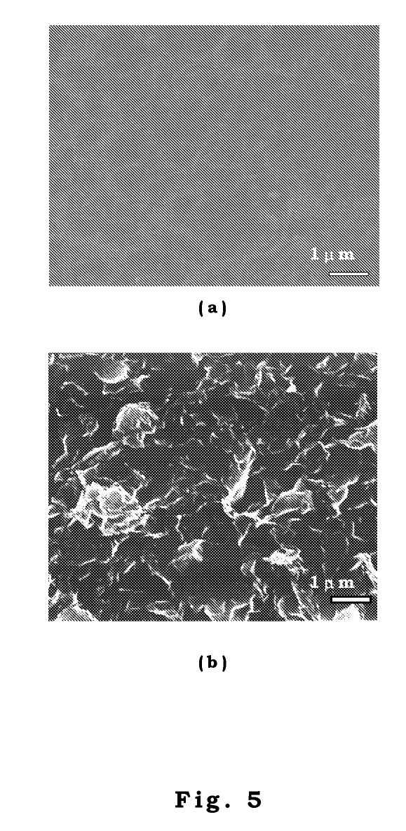

Typical surface morphology of PVAc-MMT nanocomposite film observed by SEM is shown in FIG. 5(a). The surface was even, although the exfoliated MMT domains on the surface have created some boundary traces. As it was etched by saturated acetone vapor for 15 min, clearer image of the exfoliated MMT domains could be observed by SEM as shown in FIG. 5(b). Most of the exfoliated MMT domains flattened parallel to the film surface. However, due to the fact that PVAc matrix still remained on the exfoliated MMT domains, the dispersed MMT domains in the etched surface of the films were much larger than that of neat exfoliated MMT nanoplatlets (see FIG. 1b).

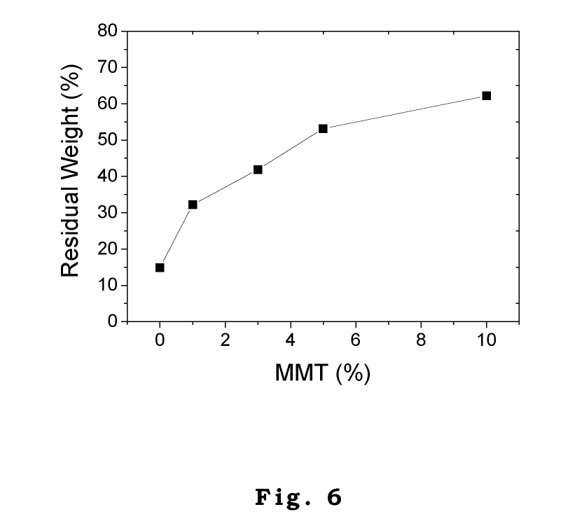

The adhesion between PVAc matrix and the exfoliated nanoplatelets in films was further investigated by Soxhlet extraction with acetone for 4 h. The residual weight percentage of the PVAc-MMT nanocomposite films versus the content of MMT was presented in FIG. 6. With higher MMT content, more PVAc matrix remained in the films, indicating that certain bonding of PVAc matrix to the exfoliated MMT nanoplatelets refrained it from removal by Soxhlet extraction with acetone. Soluble portions of PVAc matrices were then subjected to the molecular weight measurements. The weight average molecular weight (Mw) of neat PVAc was 645,000 with a PDI of 2.13. With increasing the content of MMT in the PVAc-MMT nanocomposite films, the molecular weight of PVAc matrix was slightly decreased. It might be due to the fact that the KPS initiator for preparation of the PVAc-MMT nanocomposite latex was not homogeneously dissolved in the aqueous phase. It has been intercalated into the interlayer regions of MMT so that its concentration was higher at that region. Since the polymerization reactions usually occur in the interlayer regions of MMT, the radicals on the growing chains were also easier to be quenched.

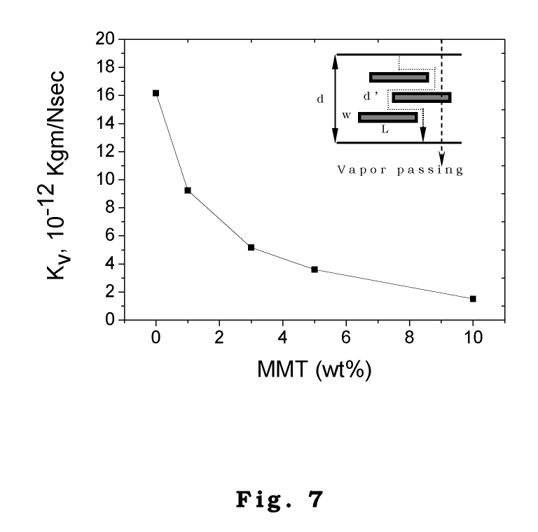

Because the water vapor can not penetrate the MMT nanoplatelets, their presence in the PVAc-MMT nanocomposite films can reduce the permeability. Indeed, FIG. 7 shows that the permeability coefficient of PVAc-MMT nanocomposite films was significantly reduced by the exfoliated MMT nanoplatelets. 10 wt % of the exfoliated MMT nanoplatelets in the film could reduce the permeability coefficient of water vapor to only 9% that of the neat PVAc. In the presence of the exfoliated MMT nanoplatelets, the water vapor has to take a longer tortuous path as schematically shown in the inserted illustration of FIG. 7.

These MMT nanoplatelets would enhance the strength of polymer. PVAc-MMT nanocomposite films and crosslinked PVAc-co-GMA-MMT nanocomposite films were as the candidates for properties analysis. The exfoliated MMT nanoplatelets were uniformly dispersed in the transparent polymeric based films. The strength of film can be enhanced with MMT, but the material became more brittle. The ability to block water vapor was improved, for the high aspect ratio of nanoplatelets effectively increased the diffusive path of vapor. These exfoliated MMT in polymer act as a strong and constructive frame or armor to enhance the chemical and fire resistance. We believe that this research can be applied to the industries in coating, adhesion, biology or other field and helpful for further development of nanotechnology or nanocomposite science.

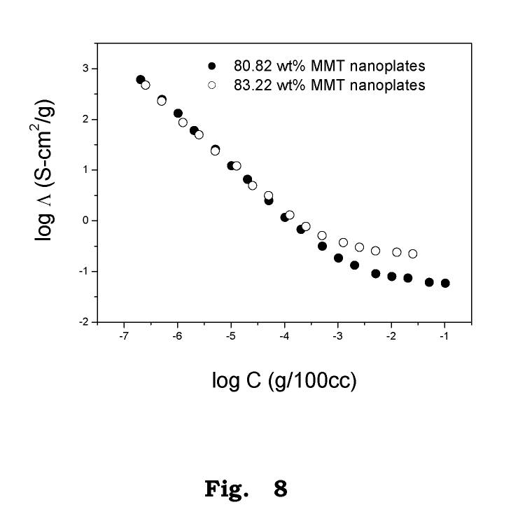

In a second embodiment of the present invention, a method to prepare an exfoliated clay aqueous solution is disclosed. At first, a clay (the cationic exchange capacity is about 7˜300 meq/100 g) and a water-soluble initiator are mixed in water to form an intermediate solution, in which the initiator is absorbed or intercalated into the clay. Furthermore, the weight of clay is about 5%˜30% weight of polymer-clay nanocomposite latex particles, and the weight of water-soluble initiator is about 10%˜1000% weight of polymer-clay nanocomposite latex particles. Then, at least one monomer from vinyl ester, acrylic and acrylamide derivatives is added into the intermediate solution for soap-free emulsion polymerization, which may also be added with some other monomers such as acrylic acid, maleic anhydride, vinyl chloride, acrylonitrile, ethylene, et al. for copolymerization. During soap-free emulsion polymerization, the radicals from the dissociated initiators will react with the monomers to form the monomer radicals, which tend to diffuse into the interlayer region of clays for further polymerization and eventually form a polymer-clay nanocomposite latex. At last, mixing a solvent with the polymer-clay nanocomposite latex to dissolve the polymer matrix, so as to remove the polymer matrix from the polymer-clay nanocomposite latex, and to form the exfoliated clay aqueous solution, wherein the clay is in the form of individual nanoplatelet as shown in FIG. 1b. Because the exfoliated clays in nanoplatelet form carry external ions, they behave like a two-dimensional electrolyte, as illustrated in FIG. 8 that the reduced conductivity of the recovered exfoliated MMT in aqueous solutions increases with the increase of exfoliated MMT content but decrease with increasing the concentration. Moreover, because the exfoliated clays in aqueous solutions still contain 5˜20 wt % polymer resin, they can be cast into a film with the polymer resin acting as a binder. As the exfoliated clay solution is cast into a film with the clay content is more than or equal to 80 wt %, the film is semi-conductive and the surface electrical resistance is less than or equal to 10⁸ ohm (Ω). The surface electrical resistance decreases with the increase of the exfoliated clay content. Thus, the exfoliated clay solutions can be applied to the electronic materials and organic/inorganic multilayer composite films.

Other modifications and variations are possibly developed in light of the above demonstrations. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method to prepare a polymer-clay nanocomposite latex, comprising:
providing a clay and a water-soluble initiator in water to form an intermediate solution; and
adding at least one monomer into the intermediate solution, wherein the monomer is selected from vinyl ester, acrylic and acrylamide derivatives for soap-free emulsion polymerization and some other monomers are optionally added for copolymerization. During the soap-free emulsion polymerization, radicals from the dissociated water-soluble initiator react with the monomers to form monomer radicals, which tend to diffuse into the interlayer region of clays for further polymerization and eventually form the polymer-clay nanocomposite latex.

2. The method according to claim 1, wherein the other monomers for copolymerization comprises one selected from the group consisting of the following: acrylic acid, maleic anhydride, vinyl chloride, acrylonitrile and ethylene.

3. The method according to claim 1, wherein the clay comprises one selected from the group consisting of the following: smectite clay, vermiculite, halloysite, sericite, and mica.

4. The method according to claim 3, wherein the smectite clay comprises one selected from the group consisting of the following: montmorillonite, saponite, hectorite, beidellite, nontronite, and stevensite.

5. The method according to claim 1, wherein the cationic exchange capacity of the clay is about 7˜300 meq/100 g.

6. The method according to claim 1, wherein the water-soluble initiator comprises one selected from the group consisting of the following: potassium persulfate (KPS), ammonium persulfate (APS) and soluble azo-initiator.

7. The method according to claim 6, wherein the soluble azo-initiator comprises one selected from the group consisting of the following: 2,2′-Azobis[2-(2-imidazolin-2-yl)propane]dihydrochloride, 2,2′-Azobis(2-methylpropionamide)dihydrochloride, and 2,2′-Azobis{2-methyl-N-[2-(1-hydroxybuthyl)]propionamide}.

8. The method according to claim 1, wherein the weight of the clay is about 1%˜30% weight of the polymer-clay nanocomposite latex particles, and the weight of the water-soluble initiator is about 2%˜20% weight of the polymer-clay nanocomposite latex particles.

9. The method according to claim 1, wherein the water-soluble initiator is absorbed or intercalated into the clay.

10. The method according to claim 1, wherein the vinyl ester comprises one selected from the group consisting of the following: vinyl acetate (VAc), vinyl propionate, and vinyl butyrate.

11. The method according to claim 1, wherein the acrylic comprises one selected from the group consisting of the following: methyl acrylate, glycidyl acrylate, glycidyl methacrylate, and methyl methacrylate.

12. The method according to claim 1, wherein the acrylamide comprises one selected from the group consisting of the following:
acrylamide, and n-isopropylacrylamide.

13. The method according to claim 1, wherein the polymer-clay nanocomposite latex is applied into a vapor-impermeable film so that it can be used as a sealing material or coating.

14. The method according to claim 13, wherein the vapor-impermeable film is poly(vinyl acetate)-clay nanocomposite.

15. The method according to claim 14, wherein the poly(vinyl acetate)-clay nanocomposite reduces the permeability coefficient of water vapor to only 9% that of the neat PVAc (100%).

16. A method to prepare an exfoliated clay solution, comprising:
providing a clay and a water-soluble initiator in water to form an intermediate solution;
providing a clay and a water-soluble initiator in water to form an intermediate solution; and
adding at least one monomer into the intermediate solution, wherein the monomer is selected from vinyl ester, acrylic and acrylamide derivatives for soap-free emulsion polymerization and some other monomers are optionally added for copolymerization. During the soap-free emulsion polymerization, radicals from the dissociated water-soluble initiator react with the monomers to form monomer radicals, which tend to diffuse into the interlayer region of clays for further polymerization and eventually form the polymer-clay nanocomposite latex; and
mixing a solvent with the polymer-clay nanocomposite latex to dissolve the polymer matrix, so as to remove the polymer matrix from the polymer-clay nanocomposite latex, and then add water to form the aqueous solution containing exfoliated clay with the residual polymer content less than or equal to 20 wt %, wherein the clay is in the form of individual nanoplatelets.

17. The method according to claim 16, wherein the other monomers for copolymerization comprises one selected from the group consisting of the following: acrylic acid, maleic anhydride, and acrylonitrile.

18. The method according to claim 16, wherein the clay comprises one selected from the group consisting of the following:
smectite clay, vermiculite, halloysite, sericite, and mica.

19. The method according to claim 16, wherein the smectite clay comprises one selected from the group consisting of the following: montmorillonite, saponite, hectorite, beidellite, nontronite, and stevensite.

20. The method according to claim 16, wherein the cationic exchange capacity of the clay is about 7˜300 meq/100 g.

21. The method according to claim 16, wherein the water-soluble initiator comprises one selected from the group consisting of the following: potassium persulfate (KPS), ammonium persulfate (APS) and soluble azo-initiator.

22. The method according to claim 21, wherein the soluble azo-initiator comprises one selected from the group consisting of the following: 2,2′-Azobis[2-(2-imidazolin-2-yl)propane]dihydrochloride, 2,2′-Azobis(2-methylpropionamide)dihydrochloride, and 2,2′-Azobis{2-methyl-N-[2-(1-hydroxybuthyl)]propionamide}.

23. The method according to claim 16, wherein the weight of the clay is about 5%˜30% weight of the polymer-clay nanocomposite latex, and the weight of the water-soluble initiator is about 10%˜1000% weight of the polymer-clay nanocomposite latex.

24. The method according to claim 16, wherein the water-soluble initiator is absorbed or intercalated into the clay.

25. The method according to claim 16, wherein the vinyl ester comprises one selected from the group consisting of the following: vinyl acetate (VAc), vinyl propionate, and vinyl butyrate.

26. The method according to claim 16, wherein the acrylic comprises one selected from the group consisting of the following: methyl acrylate, glycidyl acrylate, glycidyl methacrylate, and methyl methacrylate.

27. The method according to claim 16, wherein the acrylamide comprises one selected from the group consisting of the following:
acrylamide, and n-isopropylacrylamide.

28. The method according to claim 16, wherein the exfoliated clay aqueous solution is applied to the electronic materials and organic/inorganic multilayer composite films.

29. The method according to claim 28, wherein the exfoliated clay aqueous solution is conductive and the conductivity is increased with the content of exfoliated clay.

30. The method according to claim 28, wherein the exfoliated clay aqueous solution is cast into a film with the nanoplatelet-shaped clay, and the content of the nanoplatelet-shaped clay is more than or equal to 80 wt %.

31. The method according to claim 28, wherein the film is semi-conductive, and the surface electrical resistance is less than or equal to 10⁸ ohm (Ω).

32. The method according to claim 28, wherein the exfoliated clay aqueous solution is cast into a film, and the surface electrical resistance decreases with the increase of the nanosheet-shaped clay content.
